(19) United States
(12) Patent Application Publication
(10) Pub. No.: US 2025/0079566 A1
(43) Pub. Date: Mar. 6, 2025

(54) ENERGY STORAGE CABINET AND METHOD FOR CONTROLLING TEMPERATURE OF BATTERY

(71) Applicant: Shenzhen CLOU Electronics CO., LTD., Shenzhen (CN)

(72) Inventors: Dongfang LI, Shenzhen (CN); Jinzhi LIU, Shenzhen (CN); Juan XIE, Shenzhen (CN)

(73) Assignee: Shenzhen CLOU Electronics CO., LTD., Shenzhen (CN)

(21) Appl. No.: 18/645,552

(22) Filed: Apr. 25, 2024

(30) Foreign Application Priority Data
Aug. 31, 2023 (CN) 202311128235.4

(51) Int. Cl. H01M 10/6563; H01M 10/613; H01M 10/627; H01M 10/633

(52) U.S. Cl. CPC H01M 10/6563; H01M 10/613; H01M 10/627; H01M 10/633; H01M 2220/10

(57) ABSTRACT

Disclosed are an energy storage cabinet and a method for controlling a temperature of a battery. The energy storage includes a first housing, a battery module, an air supply portion, and an air guide portion. An air inlet plate is provided at one side of the first housing, the air inlet plate is provided with a first through hole communicated with a first accommodating cavity. The battery module is provided in the first accommodation cavity. The air guide portion is provided at a side of the air inlet plate away from the first accommodation cavity. The air guide portion has a first channel provided with a first end and a second end opposite to the first end. The first end is communicated with the first through hole. The high-speed airflow transmitted from the air supply portion flows into the first channel through the second end.

### CROSS-REFERENCE TO RELATED APPLICATION

This application claims priority to Chinese Patent Application No. 202311128235.4, all filed on Aug. 31, 2023, the entire contents of which are incorporated herein by reference for all purposes.

### FIELD

The present application relates to the field of energy storage, and in particular to an energy storage cabinet and a method for controlling a temperature of a battery.

### BACKGROUND

With the widespread application of energy storage cabinets, the performance requirements and appearance requirements of energy storage cabinets are also constantly improving. During use, energy storage cabinets are often required to have low noise, small space occupation, and high temperature consistency of the battery cells in the energy storage cabinet. In the related art, the air conditioner is usually installed at the cabinet door of the energy storage cabinet, and the high-speed cold air flowing from the air conditioner outlet will directly enter the energy storage cabinet, resulting in a large difference in the speed of the cold air in each battery module. In the related art, the maximum speed deviation of air at the inlet of each battery module in the energy storage cabinet can sometimes reach 50%, which may eventually lead to a battery cell temperature difference of 10° C. in the cabinet, ultimately shortening the battery life by more than 15%.

### SUMMARY

The main purpose of the present application is to provide an energy storage cabinet and a method for controlling a temperature of a battery to improve battery temperature uniformity and extend battery service life.

In order to at least achieve the above objectives, the present application provides an energy storage cabinet, which includes a first housing, a battery module, an air supply portion, and an air guide portion. The first housing is provided with a first accommodation cavity, where an air inlet plate is provided at one side of the first housing, the air inlet plate is provided with a first through hole, and the first through hole is communicated with the first accommodating cavity. The battery module is provided in the first accommodation cavity. The air guide portion is connected to the first housing and provided at a side of the air inlet plate away from the first accommodation cavity, where the air guide portion is provided with a first channel, and the first channel is provided with a first end and a second end opposite to the first end, the first end is communicated with the first through hole. The airflow is introduced from the second end to the air supply portion. A direction from the second end to the first end is a first direction, and along the first direction, a cross-sectional area of the first channel perpendicular to the first direction increases, and a projection plane is perpendicular to the first direction, the first end forms a first orthographic projection on the projection plane, the second end forms a second orthographic projection on the projection plane, and the second orthographic projection is located within the first orthographic projection and located at an edge of the first orthographic projection.

In an embodiment, the energy storage cabinet includes a control portion and a detection portion, the detection portion is configured to detect a temperature of the battery module, and the control portion is configured to control an opening size of the first through hole according to the temperature detected by the detection portion and control an operating mode of the air supply portion.

In an embodiment, the energy storage cabinet further includes a converter, where the first housing is provided with a second accommodation cavity, the converter is provided in the second accommodation cavity, the air guide portion is further provided with a third end, and the third end is communicated with the second accommodation cavity.

In an embodiment, the battery module includes a battery, a second housing and a fan, the second housing is provided with a third accommodation cavity, the third accommodation cavity is provided with an air inlet and an air outlet, the fan is configured to allow air to flow into the third accommodation cavity via the air inlet, and flow out from the third accommodation cavity via the air outlet.

In another aspect, the present application further provides a method for controlling a temperature of a battery, applied to the energy storage cabinet of any one embodiment as mentioned above, where the energy storage cabinet includes a detection portion and a control portion, the detection portion is configured to detect the temperature of the battery module, the control portion is configured to control operation of the air guide portion and the air supply portion according to the temperature of the battery module, and the method includes:
measuring the temperature of each battery module;
obtaining a maximum temperature Tmax, a minimum temperature Tmin and an average temperature Tave in the first accommodation cavity according to a measured temperature;
calculating a temperature difference ΔT1 in the first accommodation cavity, where a value obtained by subtracting Tmin from Tmax is ΔT1; and
adjusting an air inlet volume in the first accommodation cavity according to the temperature difference ΔT1, and adjusting a duty cycle of the fan of the battery module according to the average temperature Tave, to make the temperature of the battery module reach a set value.

In an embodiment, an opening size of the first through hole increases as the average temperature Tave increases.

In an embodiment, the battery module is provided with a fan, and a duty cycle of the fan increases as the average temperature Tave increases.

In an embodiment, after the calculating the temperature difference ΔT1 in the first accommodation cavity, the value obtained by subtracting Tmin from Tmax being ΔT1, the method further includes adjusting the operating mode of the air supply portion according to the maximum temperature Tmax, when the maximum temperature Tmax is not greater than 20° C., controlling, by the control portion, the air supply portion to turn on a heating mode, and transmitting, by the air supply portion, hot air to the first accommodation cavity;

when the maximum temperature Tmax is greater than 20° C. and is not greater than 30° C., controlling, by the control portion, the air supply portion to turn on an air supply mode, and the air supply portion is configured to supply air to the first accommodation cavity; and

when the maximum temperature Tmax is greater than 30° C., controlling, by the control portion, the air supply portion to turn on a cooling mode, and the air supply portion is configured to transmit cold air to the first accommodation cavity.

In an embodiment, the energy storage cabinet includes a plurality of battery modules provided in different areas of the first accommodation cavity, and the first housing is provided with a plurality of first through holes corresponding to the battery module in each area, the detection portion is configure to measure the temperature of the battery module in each area, and the control portion is configure to control an opening size of the first through hole in each area according to the temperature measured by the detection portion.

In an embodiment, the adjusting, by the control portion, an opening size of the first through hole according to the temperature difference ΔT1, and adjusting a duty cycle of the fan of the battery module according to the average temperature Tave, to make the temperature of the battery module reach the set value includes:
measuring, by the detection portion, temperature corresponding to each the battery module at a time interval t, where a temperature difference ΔT1 of the battery module is obtained in an nth measurement, and a temperature difference ΔT2 of the battery module is obtained in an n+1th measurement,
when the temperature difference ΔT1 is not less than 5° C. and a value obtained by subtracting ΔT1 from ΔT2 is not greater than 0, the control portion is configured to increase an opening size of the first through hole in an area corresponding to the maximum temperature Tmax, and decrease an opening size of the first through hole in the area corresponding to the minimum temperature Tmin, and
when the temperature difference ΔT1 is not less than 5° C. and the value obtained by subtracting ΔT1 from ΔT2 is greater than 0, the opening size of the first through hole is configured to keep unchanged.

In the present application, the first housing is provided with an air inlet plate. The air inlet plate is provided with a first through hole communicated with the first accommodating cavity. The battery module is disposed in the first accommodating cavity. The air portion generates the airflow to adjust the temperature of the first accommodation cavity. The air guide portion allows the airflow to flow into the first channel from the second end and then flow into the first accommodation cavity through the first end. During the air transport process, the high-speed airflow transmitted from the air supply portion flows into the first channel through the second end. On the one hand, since the cross-sectional area of the first channel gradually increases along the direction from the second end to the first end, the airflow flowing from the air supply portion will slow down in the first channel. On the other hand, since the projection of the second end is located at the edge of the projection of the first channel along the direction perpendicular to the cross-section of the first channel, the shortest flow path of the high-speed airflow flows from the second end to the second end increases in the length, and the high-speed airflow can be prevented from flowing directly to the first accommodation cavity, so that the high-speed airflow can fully decelerate in the first channel. In addition, the first housing is also provided with an air inlet plate which is provided with a first through hole. The air inlet plate can transmit the airflow from the first channel to the first accommodation cavity, and can also provide a damping effect on the airflow, so that the high-speed airflow can be filled in the first channel more uniformly, making the air outflow from the air inlet plate close to the first accommodation cavity more uniform. In this way, the airflow received by each battery module in the first accommodation cavity can be more uniform, and the temperature of each portion of the battery module can be more uniform, thereby greatly improving the service life of the battery module.

### BRIEF DESCRIPTION OF DRAWINGS

To illustrate the technical solutions according to the embodiments of the present application or the related art more clearly, the accompanying drawings for describing the embodiments or the related art are introduced briefly in the following. Apparently, the accompanying drawings in the following description are only some embodiments of the present application. Persons skilled in the art can derive other drawings from the accompanying drawings without creative efforts.

FIG. 1 is a schematic exploded structural diagram of an energy storage cabinet according to an embodiment of the present application.

FIG. 2 is a schematic structural diagram of the energy storage cabinet from a first perspective according to an embodiment of the present application.

FIG. 3 is a schematic structural diagram of the energy storage cabinet from a second perspective according to an embodiment of the present application.

FIG. 4 is a schematic cross-sectional structural diagram of the energy storage cabinet according to an embodiment of the present application.

FIG. 5 is a flowchart of a method for controlling a temperature of a battery according to an embodiment of the present application.

FIG. 6 is a flowchart of the method for controlling a temperature of a battery according to another embodiment of the present application.

The realization of the objective, functional characteristics, and advantages of the present application are further described with reference to the accompanying drawings.

### DETAILED DESCRIPTION OF EMBODIMENTS

The technical solutions of the embodiments of the present application will be described in detail below with reference to the accompanying drawings. It is obvious that the embodiments to be described are only some rather than all of the embodiments of the present application. All other embodiments obtained by persons skilled in the art based on the embodiments of the present application without creative efforts shall fall within the scope of the present application.

With the widespread application of energy storage cabinets, the performance requirements and appearance requirements of energy storage cabinets are also constantly improving. During use, energy storage cabinets are often required to have low noise, small space occupation, and high temperature consistency of the battery cells in the energy storage cabinet. In the related art, the air conditioner is usually installed at the cabinet door of the energy storage cabinet, and the high-speed cold air flowing from the air conditioner outlet will directly enter the energy storage cabinet. On the one hand, the speed difference of the cold air in each battery module is large, and the maximum deviation of air at the inlet of each battery module in the energy storage cabinet can sometimes reach 50%, which may eventually lead to a battery cell temperature difference of 10° C. in the cabinet, ultimately shortening the battery life by more than 15%. On the other hand, if the air conditioner is installed at the door of the energy storage cabinet, not only the door of the energy storage cabinet will be difficult to open, greatly increasing the opening cost of the door and the maintenance cost of the energy storage cabinet, but also the floor space of the energy storage cabinet will be greatly increased. When a plurality of energy storage cabinets are installed together, a large distance needs to be kept between each energy storage cabinet to install the air conditioner, which further increases the area occupied by the energy storage cabinets.

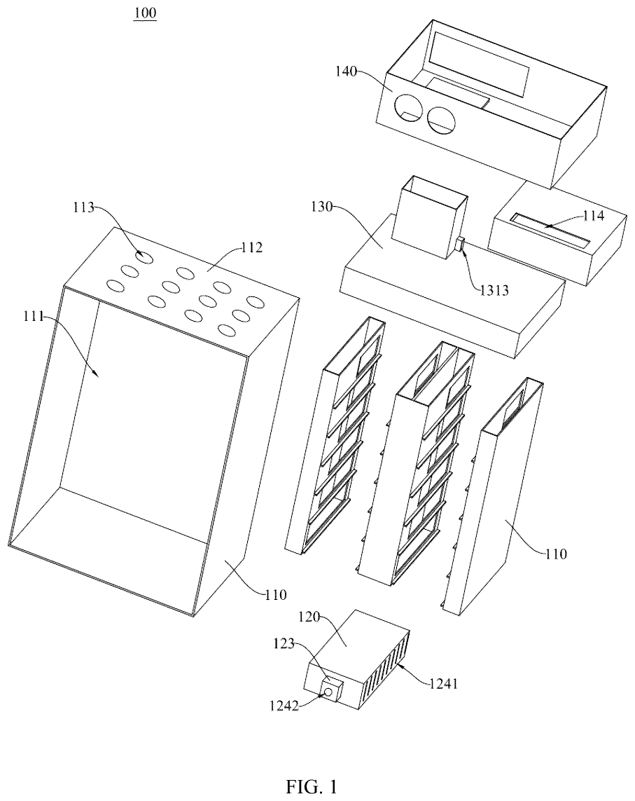

In order to solve the above problems, as shown in FIG. 1 to FIG. 4, the present application provides an energy storage cabinet 100. The energy storage cabinet 100 includes a first housing 110, a battery module 120, an air guide portion 130 and an air supply portion 140.

As shown in FIG. 1, the first housing 110 is provided with the first accommodation cavity 111. An air inlet plate 112 is provided at one side of the first housing 110. The air inlet plate 112 is provided with a first through hole 113. The air inlet plate 112 can be provided at any portion of the first accommodation cavity 111 that requires air supply. In order to optimize the temperature adjustment effect, the air inlet plate 112 is provided above the cabinet in cooperation with the air guide portion 130 of the present application. The first through hole 113 is communicated with the first accommodation cavity 111, and the first through hole 113 is configured for the temperature-adjusting airflow to circulate to the first accommodation cavity 111.

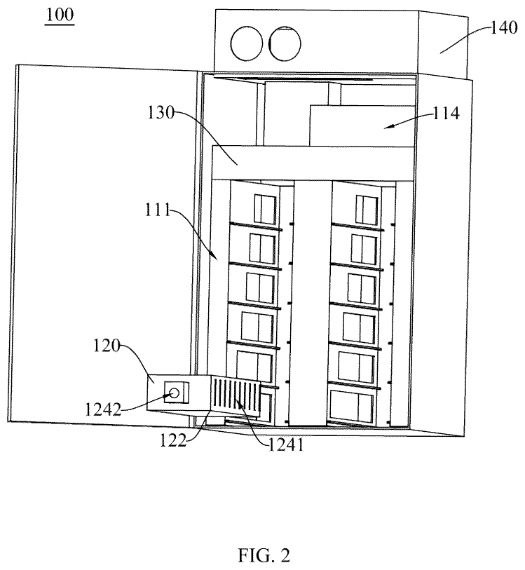

As shown in FIG. 2, the battery module 120 is provided in the first receiving cavity 111. It can be understood that in some embodiments, in order to facilitate the arrangement of the battery 121, the first housing 110 may include a frame assembly, and the frame assembly is provided with the arrangement position of the battery module 120, which is not limited here.

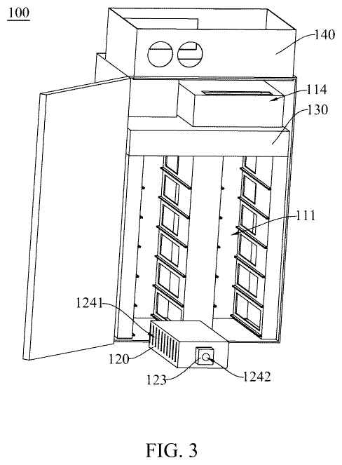

As shown in FIG. 3, the air guide portion 130 is connected to the first housing 110 and is provided at the side of the air inlet plate 112 away from the first accommodation cavity 111. The air guide portion 130 is provided with the first channel 131, and the first channel 131 is provided with a first end 1311 and the second end 1312 opposite to the first end 1311. The first end 1311 is communicated with the first through hole 113. The air guide portion 130 is connected to the first housing 110. The air guide portion 130 can be directly connected to a side of the air inlet plate 112 away from the first accommodation cavity 111. Furthermore, the air inlet plate 112 can be connected to the peripheral wall of the first channel 131, which further enables the first end 1311 to communicate with the first through hole 113, and the airflow can flow from the first end 1311 into the first through hole 113 and the first accommodation cavity 111.

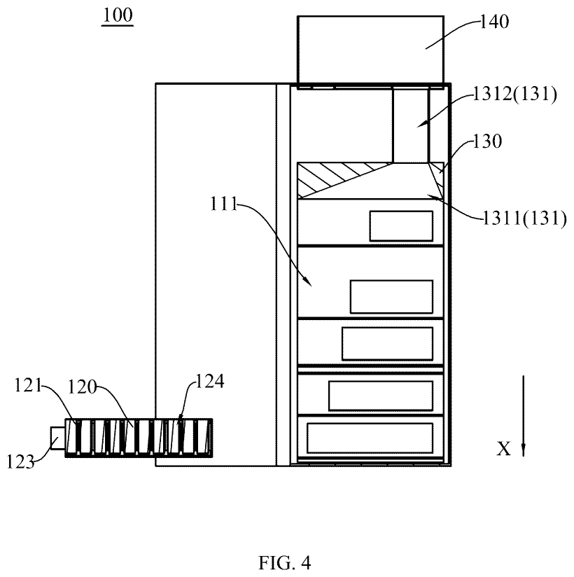

As shown in FIG. 4, airflow is introduced to the air supply portion 140 from the second end 1312. The air supply portion 140 may be configured as a horizontal air conditioner. The horizontal air conditioner is provided with an air outlet 1242 and transmits airflow to the air guide portion 130 via the air outlet 1242. The airflow flows out from the air supply portion 140, enters the first channel 131 through the second end 1312, and then flows into the first through hole 113 through the first end 1311. Finally, the airflow enters the first accommodation cavity 111 via the first through hole 113, so that the air portion 140 can adjust the temperature in the first accommodation cavity 111.

As shown in FIG. 4, the direction from the second end 1312 to the first end 1311 is the first direction X. Along the first direction X, the cross-sectional area of the first channel 131 perpendicular to the first direction X gradually increases. The projection plane is perpendicular to the first direction X. The first end 1311 forms a first orthographic projection on the projection plane, and the second end forms a second orthographic projection on the projection plane. The second orthographic projection is located within the first orthographic projection and is located at an edge of the first orthographic projection. It should be noted that along the direction from the second end 1312 to the first end 1311, the cross-sectional area of the first end 1311 remains unchanged, and the cross-sectional area of the second end 1312 also remains unchanged. The embodiment in which the cross-sectional area gradually increases along the second end 1312 to the first end 1311 of the first channel 131 also meets the requirement that the cross-sectional area of the first channel 131 gradually increases along the second end 1312 to the first end 1311. Along the direction perpendicular to the cross-section of the first channel 131, the projection of the second end 1312 is located at the projection edge of the first end 1311. In the projection plane parallel to the cross-section of the first channel 131, along the direction perpendicular to the cross-section of the first channel 131, the first end 1311 forms a first projection on the projection plane, and the second end 1312 forms a second projection on the projection plane. The first projection and the second projection are set on different axes, and the second projection is provided at the edge of the first projection. The second projection can be completely provided within the first projection, or the second projection can be completely provided outside the first projection, or the second projection can also partially overlap with the first projection, as long as the first end 1311 and the second end 1312 are not arranged on the same axis.

In the present application, the first housing 110 is provided with an air inlet plate 112. The air inlet plate 112 is provided with a first through hole 113 communicated with the first accommodating cavity 111. The battery module 120 is disposed in the first accommodating cavity 111. The air portion 140 generates the airflow to adjust the temperature of the first accommodation cavity 111. The air guide portion 130 allows the airflow to flow into the first channel 131 from the second end 1312 and then flow into the first accommodation cavity 111 through the first end 1311. During the air transport process, the high-speed airflow transmitted from the air supply portion 140 flows into the first channel 131 through the second end 1312. On the one hand, since the cross-sectional area of the first channel 131 gradually increases along the direction from the second end 1312 to the first end 1311, the airflow flowing from the air supply portion 140 will slow down in the first channel 131. On the other hand, since the projection of the second end 1312 is located at the edge of the projection of the first channel 131 along the direction perpendicular to the cross-section of the first channel 131, the shortest flow path of the high-speed airflow flows from the second end 1312 to the second end 1312 increases in the length, and the high-speed airflow can be prevented from flowing directly to the first accommodation cavity 111, so that the high-speed airflow can fully decelerate in the first channel 131. In addition, the first housing 110 is also provided with an air inlet plate 112 which is provided with a first through hole 113. The air inlet plate 112 can transmit the airflow from the first channel 131 to the first accommodation cavity 111, and can also provide a damping effect on the airflow, so that the high-speed airflow can be filled in the first channel 131 more uniformly, making the air outflow from the air inlet plate 112 close to the first accommodation cavity 111 more uniform. Moreover, the first through hole 113 can be provided at any position of the first housing 110 that requires air supply. The first through hole 113 is provided at the air inlet plate 112, which can not only make the inlet air speed in the first accommodation cavity 111 more uniform, but also can directly supply air to various parts of the first accommodation cavity 111 according to different usage requirements. The arrangement of the air inlet plate 112 greatly improves the uniformity and coverage of the air. The uniform airflow flowing from the first through hole 113 can adjust the temperature of each battery module 120 in the first accommodation cavity 111, thereby making the temperature of each portion of the battery module 120 more uniform, and the service life of the battery module 120 is also greatly improved. It can be understood that the air supply portion 140 is provided at the side of the air guide portion 130 away from the first housing 110, and the air guide portion 130 is provided at the upper end of the first housing 110. That is to say, the air supply portion 140 is provided at the upper end of the first housing 110. The arrangement of the air supply portion 140 not only makes it easier to open and close the first housing 110, but also effectively reduces the floor area of the energy storage cabinet 100.

It should be noted that the air guide portion 130 may also be configured with a static pressure cavity, which is connected to the first housing 110. The airflow flows into the static pressure cavity through the air outlet portion, and then flows into the first accommodation cavity 111 through the static pressure cavity. The static pressure cavity is also called a stable pressure chamber. The static pressure cavity is connected to a large space box at the air supply port, and is used in the air supply system and the return air exhaust system to reduce dynamic pressure, increase static pressure, stabilize airflow, and reduce airflow noise and vibration. The static pressure cavity can not only be used to reduce noise in ventilation system and the air conditioner system, but also can be used to obtain uniform static pressure air, reduce dynamic pressure loss, and improve the overall performance of the ventilation system.

In some embodiments, in order to achieve accurate control on the temperature required by the battery module 120, the energy storage cabinet 100 can directly detect the temperature of each battery module 120 and control the air outlet volume, the air outlet mode of the air supply portion 140, and the size of the air outlet of the air guide portion 130 to regulate the airflow entering the first accommodation cavity 111, thereby adjusting the temperature of the battery module 120 in the first accommodation cavity 111. As shown in FIG. 3 and FIG. 4, in this embodiment, the energy storage cabinet 100 includes a control portion and a detection portion. The detection portion is configured to detect the temperature of the battery module 120, the control portion can control the opening size of the first through hole 113 and control the operation mode of the air supply portion 140 according to the temperature detected by the detection portion. The opening size of the first through hole 113 can be measured by the opening ratio. The opening ratio of the first through hole 113 is the ratio of the actual opening area to the maximum opening area of the first through hole 113. The larger the difference between the actual temperature in the first accommodation cavity 111 and the set temperature, the larger the opening ratio of the first through hole 113. In some embodiments, the air inlet plate 112 may also be provided with multiple first through holes 113. In this case, the opening ratio of the first through holes 113 may be the ratio of sum of the actual opening areas of each first through hole 113 to the sum of the maximum opening areas. According to different temperature requirements, the air supply assembly can be set to the cooling mode to transmit cold air to the first accommodation cavity 111, or can be set to the heating mode to transmit hot air to the first accommodation cavity 111, or can be set to the air supply mode to transmit natural airflow to any accommodating cavity, which is not limited here.

In some embodiments, in order to prevent the heat generated by other components of the energy storage cabinet from affecting the operation of the battery module 120, or the heat generated by other components from affecting the accuracy of the temperature measurement of the battery 121, the first housing 110 can also be provided with another cavity independent of the first containing cavity 111, so that the operation of the battery module 120 is not affected by other components. As shown in FIG. 3 and FIG. 4, in this embodiment, the energy storage cabinet 100 also includes a converter, the first housing 110 is provided with the second accommodation cavity 114, and the converter is provided in the second accommodation cavity 114. The air guide portion 130 is also provided with a third end 1313, and the third end 1313 is communicated with the second accommodation cavity 114. That is to say, the air supply portion 140 can also transmit airflow to the second accommodation cavity 114, so that each component in the second accommodation cavity 114 is provided with a suitable operation environment.

As shown in FIG. 2 and FIG. 3, in some embodiments, in order to improve the temperature control capability of the battery module 120, the battery module 120 may be provided with a fan 123 assembly, so that heat exchange can be performed more sufficient between the airflow in the first accommodation cavity 111 and the battery module 120. In this embodiment, the battery module 120 includes a battery 121, a second housing 122 and a fan 123. The second housing 122 is provided with a third accommodation cavity 124. The third accommodation cavity 124 is provided with an air inlet 1241 and an air outlet 1242. The fan 123 is configured to make the airflow flow into the third accommodation cavity 124 via the air inlet 1241 and flow out from the third accommodation cavity 124 via the air outlet 1242. To enhance the flow of air, the second housing 122 may be provided with multiple sets of air inlets 1241, and each group of air inlets 1241 may be arranged at different sides of the second housing 122.

In the second aspect of the present application, a method for controlling a temperature of a battery is further provided, which is applied to the energy storage cabinet 100 of any of the above embodiments. The energy storage cabinet 100 includes a detection portion and a control portion. The detection portion is configured to detect the temperature of the battery module 120, and the control portion is configured to control operation of the air guide portion 130 and the air supply portion 140 according to the temperature of the battery module 120.

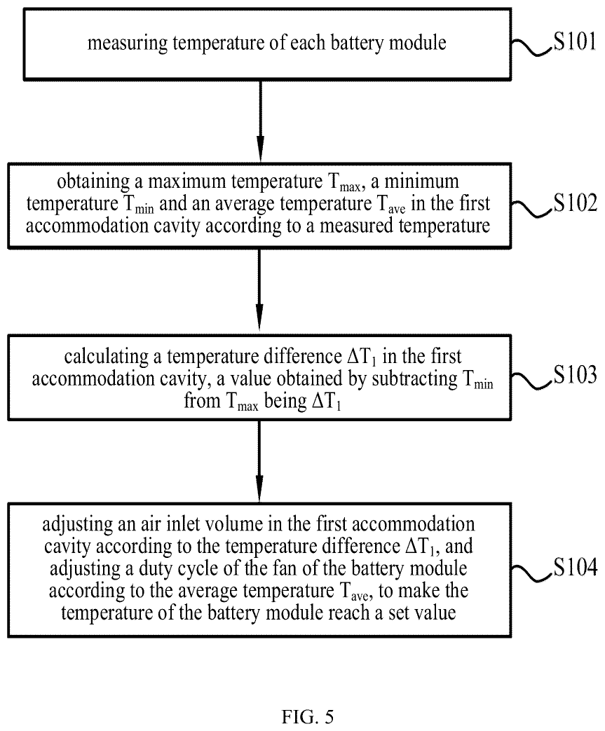

As shown in FIG. 5, the method for controlling the temperature of the battery includes:
S101, measuring temperature of each battery module 120;
S102, obtaining a maximum temperature Tmax, a minimum temperature Tmin and an average temperature Tave in the first accommodation cavity 111 according to a measured temperature;
S103, calculating a temperature difference ΔT1 in the first accommodation cavity 111, a value obtained by subtracting Tmin from Tmax being ΔT1; and
S104, adjusting an air inlet volume in the first accommodation cavity 111 according to the temperature difference ΔT1, and adjusting a duty cycle of the fan 123 of the battery module 120 according to the average temperature Tave, to make the temperature of the battery module 120 reach a set value.

The control portion usually adjusts the air supply portion 140 based on the maximum temperature of the battery module 120. The adjustment parameter is single, which greatly reduces the adjustment accuracy of the air supply portion 140 on the battery module 120. In the method for controlling the temperature of the battery of present application, the control system adjusts each component of the energy storage cabinet 100 in combination with multiple parameters of the maximum temperature Tmax, the minimum temperature Tmin, the average temperature Tave and the temperature difference ΔT1 of the battery module 120, thereby greatly improving the temperature control accuracy of the air supply portion 140 on the battery 121. Under the same temperature adjustment requirements, the energy consumption of the energy storage cabinet 100 can also be greatly reduced by using the adjustment method of the present application.

In some embodiments, in order to adjust the temperature of the battery module 120 in the first accommodation cavity 111, the control portion can regulate the air outlet of the air guide portion 130. The control portion can control the opening size of the first through hole 113, the first end 1311 and the second end 1312 to change the air inlet volume of the first accommodation cavity 111, thereby adjusting the temperature of the first accommodation cavity 111. In this embodiment, the opening size of the first through hole 113 increases with the increase of the average temperature Tave. The opening size of the first through hole 113 can be controlled according to the opening ratio of the first through hole 113, which is not repeated here. In addition, to enhance the accurate control on the temperature of each battery module 120 in the first accommodation cavity 111, the control portion can also control the power of the fan 123 at the battery module 120. The battery module 120 is provided with a fan 123, and the duty cycle of the fan 123 increases as the average temperature Tave increases. It can be understood that, for a single battery module 120, the maximum temperature Tmax, the minimum temperature Tmin, and the average temperature Tave are respectively the corresponding maximum value, the minimum value, and the average of all measurement values measured directly in each required portion of the battery module 120. For multiple battery modules 120, the maximum temperature Tmax, the minimum temperature Tmin, and the average temperature Tave are respectively the corresponding maximum value, the corresponding minimum value, and the corresponding average of all temperature measurement values measured directly in each required portion of the battery module 120.

In some embodiments, when the average temperature Tave is greater than 34°, the opening ratio of the first through hole 113 corresponding to the battery module 120 can be set to 80%. When the average temperature Tave is not less than 33° and is less than 34°, the opening ratio of the first through hole 113 corresponding to the battery module 120 can be set to 60%. When the average temperature Tave is not less than 32° and is less than 33°, the opening ratio of the first through hole 113 corresponding to the battery module 120 can be set to 40%. When the average temperature Tave is less than 32°, the opening ratio of the first through hole 113 corresponding to the battery module 120 can be set to 20%. When the average temperature Tave of a certain battery module 120 is greater than 34°, the fan operation duty cycle corresponding to the battery module 120 can be set to 100%. When the average temperature Tave of the battery module 120 is not less than 33° and is less than 34°, the fan duty cycle corresponding to the battery module 120 can be set to 90%. When the average temperature Tave of the battery module 120 is not less than 32° and is less than 33°, the fan duty cycle of the fan corresponding to the battery module 120 can be set to 80%. When the average temperature Tave of the battery module 120 is not less than 32° and is less than 33°, the fan duty cycle of the fan corresponding to the battery module 120 can be set to 70%. When the average temperature Tave of the battery module 120 is not less than 31° and is less than 32°, the fan duty cycle of the fan corresponding to the battery module 120 can be set to 60%. When the average temperature Tave of the battery module 120 is not less than 30° and is less than 31°, the fan duty cycle of the fan corresponding to the battery module 120 can be set to 50%. When the average temperature Tave of the battery module 120 is less than 28°, the fan duty cycle of the fan corresponding to the battery module 120 can be set to 20%. More details will not be repeated here.

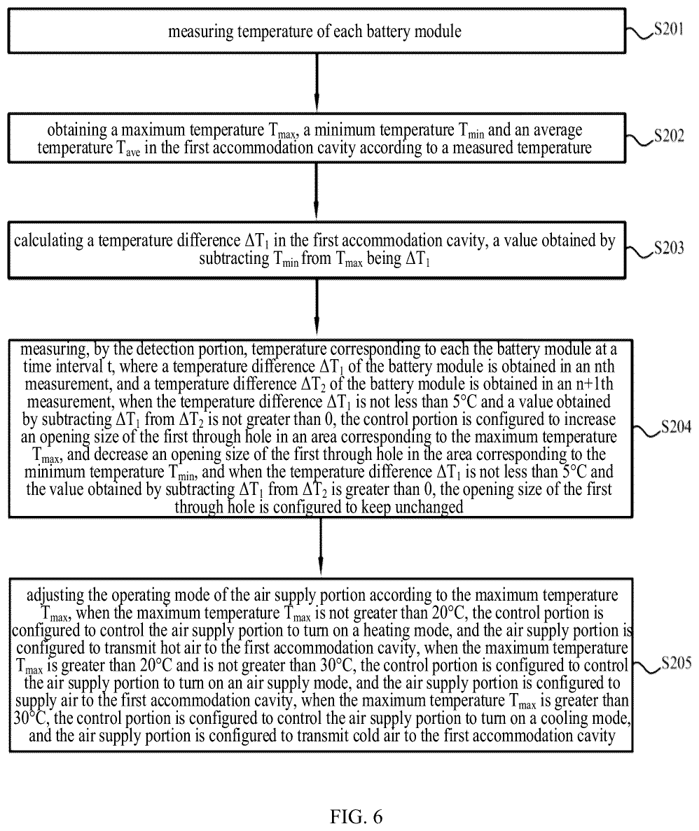

As shown in FIG. 6, in some implementations, in order to more accurately adjust the operating mode of the air supply portion 140 according to the temperature control requirements of the battery module 120, in the present application, after the calculating the temperature difference ΔT1 in the first accommodation cavity 111, the value obtained by subtracting Tmin from Tmax being ΔT1, the method for controlling the temperature of the battery further includes:

S205, adjusting the operating mode of the air supply portion 140 according to the maximum temperature Tmax.

When the maximum temperature Tmax is not greater than 20° C., the control portion is configured to control the air supply portion 140 to turn on a heating mode, and the air supply portion 140 is configured to transmit hot air to the first accommodation cavity 111.

When the maximum temperature Tmax is greater than 20° C. and is not greater than 30° C., the control portion is configured to control the air supply portion 140 to turn on an air supply mode, and the air supply portion 140 is configured to supply air to the first accommodation cavity 111.

When the maximum temperature Tmax is greater than 30° C., the control portion is configured to control the air supply portion 140 to turn on a cooling mode, and the air supply portion 140 is configured to transmit cold air to the first accommodation cavity 111.

Adjusting the operating mode of the air supply portion 140 according to different temperatures can make the energy storage cabinet 100 better meet the operation requirements of the battery 121 and increase the service life of the battery 121. When the maximum temperature Tmax of the battery module 120 in the first accommodation cavity 111 is measured to be 15°, 18°, or 20°, the air supply portion 140 is adjusted to the heating mode, and the air supply portion 140 generates hot air. The hot air will enter the first accommodation cavity 111 through the guide portion 130, so that the battery module 120 can be kept in the environment with a temperature suitable for operation, thereby effectively avoiding a too low temperature affecting the service life. When the maximum temperature Tmax of the battery module 120 in the first accommodation cavity 111 is measured to be 23°, 25° or 30°, the air supply portion 140 is adjusted to the air supply mode, and the air supply portion 140 will transmit the air at ambient temperature to the first accommodation cavity 111 through the air guide portion 130, which can not only keep the battery module 120 at a temperature suitable for operation, but also effectively save the energy loss of the air supply portion 140. When the maximum temperature Tmax of the battery module 120 in the first accommodation cavity 111 is measured to be 31°, 35° or 40°, the air supply portion 140 is adjusted to the cooling mode, the air supply portion 140 generates cold air. The cold air will enter the first accommodation cavity 111 through the air guide portion 130, so that the battery module 120 can be kept in the environment with a temperature suitable for operation, thereby effectively avoiding a too high temperature damage or affecting the service life.

In some embodiments, in order to accurately control the temperatures in different areas of the first accommodation cavity 111 and reduce the energy loss due to temperature adjustment, the air inlet volume of the first accommodation cavity 111 can be controlled in the energy storage cabinet 100 through a method that different areas are controlled, respectively. In this embodiment, the energy storage cabinet 100 includes a plurality of battery modules 120 arranged in different areas of the first accommodation cavity 111. The first housing 110 is provided with a plurality of first through holes 113 corresponding to the battery modules 120 in each area. The detection portion measures the temperature of the battery module 120 in each area, and the control portion controls the opening size of the first through hole 113 in each area respectively based on the temperature measured by the detection portion.

In some embodiments, in order to adapt to temperature adjustment under a large temperature difference, the adjusting, by the control portion, an opening size of the first through hole 113 according to the temperature difference ΔT1, and adjusting a duty cycle of the fan 123 of the battery module 120 according to the average temperature Tave, to make the temperature of the battery module 120 reach the set value includes:

measuring, by the detection portion, temperature corresponding to each the battery module 120 at a time interval t. A temperature difference ΔT1 of the battery module is obtained in an nth measurement, and a temperature difference ΔT2 of the battery module is obtained in an n+1th measurement.

When the temperature difference ΔT1 is not less than 5° C. and a value obtained by subtracting ΔT1 from ΔT2 is not greater than 0, the control portion is configured to increase an opening size of the first through hole 113 in an area corresponding to the maximum temperature Tmax, and decrease an opening size of the first through hole 113 in the area corresponding to the minimum temperature Tmin.

When the temperature difference ΔT1 is not less than 5° C. and the value obtained by subtracting ΔT1 from ΔT2 is greater than 0, the opening size of the first through hole keeps unchanged.

It should be noted that all the directional indications (such as up, down, left, right, front, rear . . . ) in the embodiments of the present application are only used to explain the relative positional relationship, movement, or the like of the components in a certain posture. If the specific posture changes, the directional indication will change accordingly.

Besides, the descriptions associated with, e.g., “first” and “second,” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature. Further, the description “and/or” includes three parallel solutions. Taking “A and/or B” as an example, it includes solution A, or solution B, or a solution that satisfies both A and B at the same time. In addition, the technical solutions of the various embodiments can be combined with each other, but the combinations must be based on the realization of those skilled in the art. When the combination of technical solutions is contradictory or cannot be achieved, it should be considered that such a combination of technical solutions does not exist, nor does it fall within the scope of the present application.

The above are only some embodiments of the present application, and do not limit the scope of the present application thereto. Under the concept of this application, any equivalent structural transformation made according to the description and drawings of the present application, or direct/indirect application in other related technical fields shall fall within the claimed scope of the present application.

What is claimed is:

1. An energy storage cabinet comprising:
a first housing provided with a first accommodation cavity, wherein an air inlet plate is provided at one side of the first housing, the air inlet plate is provided with a first through hole, and the first through hole is communicated with the first accommodating cavity;
a battery module provided in the first accommodation cavity;
an air guide portion connected to the first housing and provided at a side of the air inlet plate away from the first accommodation cavity, wherein the air guide portion is provided with a first channel, and the first channel is provided with a first end and a second end opposite to the first end, the first end is communicated with the first through hole; and
an air supply portion, wherein airflow is introduced from the second end,
wherein a direction from the second end to the first end is a first direction, and along the first direction, a cross-sectional area of the first channel perpendicular to the first direction increases; and
wherein a projection plane is perpendicular to the first direction, the first end forms a first orthographic projection on the projection plane, the second end forms a second orthographic projection on the projection plane, and the second orthographic projection is located within the first orthographic projection and located at an edge of the first orthographic projection.

2. The energy storage cabinet according to claim 1, wherein
the energy storage cabinet comprises a control portion and a detection portion;
the detection portion is configured to detect a temperature of the battery module; and
the control portion is configured to control an opening size of the first through hole according to the temperature detected by the detection portion and control an operating mode of the air supply portion.

3. The energy storage cabinet according to claim 1, further comprising a converter,
wherein the first housing is provided with a second accommodation cavity, the converter is provided in the second accommodation cavity, the air guide portion is further provided with a third end, and the third end is communicated with the second accommodation cavity.

4. The energy storage cabinet according to claim 1, wherein
the battery module comprises a battery, a second housing and a fan;
the second housing is provided with a third accommodation cavity;
the third accommodation cavity is provided with an air inlet and an air outlet; and
the fan is configured to allow air to flow into the third accommodation cavity via the air inlet, and flow out from the third accommodation cavity via the air outlet.

5. A method for controlling a temperature of a battery, applied to the energy storage cabinet according to claim 1, wherein the energy storage cabinet comprises a detection portion and a control portion, the detection portion is configured to detect the temperature of the battery module, the control portion is configured to control operation of the air guide portion and the air supply portion according to the temperature of the battery module, and the method comprises:
measuring the temperature of each battery module;
obtaining a maximum temperature Tmax, a minimum temperature Tmin and an average temperature Tave in the first accommodation cavity according to a measured temperature;
calculating a temperature difference ΔT1 in the first accommodation cavity, wherein a value obtained by subtracting Tmin from Tmax is ΔT1; and
adjusting an air inlet volume in the first accommodation cavity according to the temperature difference ΔT1, and adjusting a duty cycle of the fan of the battery module according to the average temperature Tave, to make the temperature of the battery module reach a set value.

6. The method according to claim 5, wherein an opening size of the first through hole increases as the average temperature Tave increases.

7. The method according to claim 5, wherein the battery module is provided with a fan, and a duty cycle of the fan increases as the average temperature Tave increases.

8. The method according to claim 5, wherein after the calculating the temperature difference ΔT1 in the first accommodation cavity, the value obtained by subtracting Tmin from Tmax being ΔT1, the method further comprises adjusting the operating mode of the air supply portion according to the maximum temperature Tmax,
when the maximum temperature Tmax is not greater than 20° C., controlling, by the control portion, the air supply portion to turn on a heating mode, and transmitting, by the air supply portion, hot air to the first accommodation cavity;
when the maximum temperature Tmax is greater than 20° C. and is not greater than 30° C., controlling, by the control portion, the air supply portion to turn on an air supply mode, and the air supply portion is configured to supply air to the first accommodation cavity; and
when the maximum temperature Tmax is greater than 30° C., controlling, by the control portion, the air supply portion to turn on a cooling mode, and the air supply portion is configured to transmit cold air to the first accommodation cavity.

9. The method according to claim 5, wherein the energy storage cabinet comprises a plurality of battery modules provided in different areas of the first accommodation cavity, and the first housing is provided with a plurality of first through holes corresponding to the battery module in each area, the detection portion is configure to measure the temperature of the battery module in each area, and the control portion is configure to control an opening size of the first through hole in each area according to the temperature measured by the detection portion.

10. The method according to claim 9, wherein the adjusting, by the control portion, an opening size of the first through hole according to the temperature difference ΔT1, and adjusting a duty cycle of the fan of the battery module according to the average temperature Tave, to make the temperature of the battery module reach the set value comprises:
measuring, by the detection portion, temperature corresponding to each the battery module at a time interval t, wherein a temperature difference ΔT1 of the battery module is obtained in an nth measurement, and a temperature difference ΔT2 of the battery module is obtained in an n+1th measurement,
when the temperature difference ΔT1 is not less than 5° C. and a value obtained by subtracting ΔT1 from ΔT2 is not greater than 0, the control portion is configured to increase an opening size of the first through hole in an area corresponding to the maximum temperature Tmax, and decrease an opening size of the first through hole in the area corresponding to the minimum temperature Tmin, and
when the temperature difference ΔT1 is not less than 5° C. and the value obtained by subtracting ΔT1 from ΔT2 is greater than 0, the opening size of the first through hole is configured to keep unchanged.
